(19) United States
(12) Patent Application Publication
(10) Pub. No.: US 2025/0012732 A1
(43) Pub. Date: Jan. 9, 2025

(54) SURFACE INSPECTION APPARATUS

(71) Applicant: Hitachi High-Tech Corporation, Tokyo (JP)

(72) Inventors: Toshifumi HONDA, Tokyo (JP); Takeru UTSUGI, Tokyo (JP); Masato ISHIZUKA, Tokyo (JP); Ryuji UKAI, Tokyo (JP)

(21) Appl. No.: 18/709,996

(22) PCT Filed: Jan. 12, 2022
(86) PCT No.: PCT/JP2022/000714

§ 371 Date: May 14, 2024

(51) Int. Cl. G01N 21/88; G01N 21/956

(52) U.S. Cl. CPC G01N 21/8806; G01N 21/956; G01N 2021/8822; G01N 2021/8848

(57) ABSTRACT

A surface inspection apparatus includes a differential interference contrast detection system. Illumination light is emitted to positions deviated by a predetermined shear amount as two illumination spots having different phases. Light is generated in first and second polarization directions different from each other from interference light obtained by interfering reflected light of the two illumination spots from a surface of a sample. Light in the first and second polarization directions is converted to generate first and second interference signals. A signal processing device is configured to process the first and second interference signals, and the first and second polarization directions of the light generated by the differential interference contrast detection system are set such that an intensity of the first interference signal and an intensity of the second interference signal are the same at an operation point at which there is no phase difference between the two illumination spots.

### TECHNICAL FIELD

The present invention relates to a surface inspection apparatus that inspects a sample surface and outputs a position, a type, a size, and the like of a defect.

### BACKGROUND ART

In a manufacturing line of a semiconductor substrate, a thin film substrate, or the like, a defect on a surface of the semiconductor substrate, the thin film substrate, or the like is inspected to improve a yield of a product. As a defect inspection apparatus used for the defect inspection, there is known an apparatus that measures a surface shape of a sample surface by using differential interference contrast and acquires detailed information on a position, a shape, a size, and the like of a defect (PTL 1).

A smooth surface shape can be detected with high sensitivity by differential interference contrast measurement. In a method disclosed in PTL 1, an inspection target surface height is restored based on a differential height signal obtained by scanning an inspection target surface. Specifically, a surface height of a sample surface that is an inspection target is restored by adding height displacement between shear amounts that are indicated by the differential interference contrast for each distance corresponding to the shear amount which is a distance between two spots of beams emitted by a differential interference detection system onto the sample surface. In this method, highly sensitive defect detection is expected to be performed particularly for a defect with a low aspect ratio of a micrometer order in a horizontal direction and a nanometer order in a height direction.

### CITATION LIST

### Patent Literature

PTL 1: WO2020/208680
PTL 2: JP2015-197320A

### SUMMARY OF INVENTION

### Technical Problem

The differential interference detection system disclosed in PTL 1 is not robust against noise mixed into the height displacement added for each shear amount. It has been considered that the noise included in the height displacement between the shear amounts is random noise, and as a result of studies by the inventors, it has been found that dominant factors for dominant noise in the differential interference contrast measurement, which causes an error of the height restoration, are a change in reflection direction of the sample surface, a contrast change other than the surface height displacement due to a change in reflectance, and interference between a detection signal and stray light due to back surface reflections of an optical component. In the detection system disclosed in PTL 1, the noise which is important for measuring the height displacement of the nanometer order cannot be sufficiently prevented. Further, when light having a single wavelength is used for illumination, a reflection-type differential interference microscope can only uniquely measure the height displacement up to ±¼ of a wavelength, and a transmission-type differential interference microscope can only uniquely measure the height displacement up to ±⅛ of a wavelength. If the height displacement of the sample surface exceeds these values, aliasing of the contrast occurs, resulting in large height measurement errors, which could not be addressed.

An object of the invention is to achieve both high sensitivity and robustness of a surface inspection apparatus. Accordingly, robust, highly accurate, and wide-dynamic range surface height measurement is implemented.

### Solution to Problem

A surface inspection apparatus that is an embodiment of the invention includes: a stage configured to support a sample; a differential interference contrast illumination system configured to emit illumination light; a differential interference contrast detection system configured to emit the illumination light to positions deviated by a predetermined shear amount as two illumination spots having different phases and generate light in a first polarization direction and a second polarization direction different from each other from interference light obtained by interfering reflected light of the two illumination spots from a surface of the sample; a first sensor configured to photoelectrically convert the light in the first interference polarization direction to generate a first signal; a second sensor configured to photoelectrically convert the light in the second polarization direction to generate a second interference signal; and a signal processing device configured to process the first interference signal and the second interference signal, in which the first polarization direction and the second polarization direction of the light generated by the differential interference contrast detection system are set such that an intensity of the first interference signal and an intensity of the second interference signal are the same at an operation point at which there is no phase difference between the two illumination spots.

### Advantageous Effects of Invention

The invention provides a surface inspection apparatus that can perform highly sensitive inspection while preventing an influence of optical noise.

Other problems and novel features will become apparent from the description of the present specification and the accompanying drawings.

### BRIEF DESCRIPTION OF DRAWINGS

FIG. 1 is a schematic diagram of a configuration example of a surface inspection apparatus.

FIG. 2 is a schematic diagram showing an example of a scanning trajectory on a sample by a scanning device.

FIG. 3 is a schematic diagram showing another example of the scanning trajectory of the sample by the scanning device.

FIG. 4 is a schematic diagram of an attenuator.

FIG. 5 schematically shows a positional relationship between an optical axis of illumination light from a dark-field illumination optical system and an illumination intensity distribution shape.

FIG. 6 schematically shows a positional relationship between the optical axis of the illumination light from the dark-field illumination optical system and the illumination intensity distribution shape.

FIG. 7 is a top view of a region in which a detection optical system collects scattered light.

FIG. 8 is a diagram showing an optical system of a differential interference contrast detection system.

FIG. 9A is a diagram showing a change in light amount of an S-polarized component and a P-polarized component when a phase between illumination spots changes.

FIG. 9B is a scatter diagram of a light amount of the S-polarized component and a light amount of the P-polarized component when the phase between the illumination spots changes.

FIG. 10A is a diagram showing a change in light amount when a phase between the illumination spots changes when a polarization direction to be detected is deviated by ±22.5 degrees from a polarization direction of interference light from a flat part.

FIG. 10B is a scatter diagram of the light amount when a phase between the illumination spots changes when the polarization direction to be detected is deviated by ±22.5 degrees from the polarization direction of the interference light from the flat part.

FIG. 11A is a diagram showing a change in light amount when a phase between the illumination spots changes when the polarization direction to be detected is deviated by ±30 degrees from the polarization direction of interference light from the flat part.

FIG. 11B is a scatter diagram of the light amount when a phase between the illumination spots changes when the polarization direction to be detected is deviated by ±30 degrees from the polarization direction of the interference light from the flat part.

FIG. 12A is a graph showing a calculation result of an interference signal maximum detection light amount.

FIG. 12B is a diagram showing a change in light amount when a phase between the illumination spots changes when the polarization direction to be detected is deviated by ±67.5 degrees from the polarization direction of interference light from the flat part.

FIG. 13A shows a light reception unit of a line sensor.

FIG. 13B shows a light reception unit of a line sensor.

FIG. 14 is a block diagram of a differential interference contrast processing unit.

FIG. 15 is a diagram showing a modification of the optical system of the differential interference contrast detection system.

FIG. 16 is an arrangement diagram of a bar-shaped mirror that reflects light of a dark-field illumination system, emits the reflected light on a sample surface, and cuts directly reflected light from the sample surface.

### DESCRIPTION OF EMBODIMENTS

Hereinafter, an embodiment according to the invention will be described with reference to the drawings.

A surface inspection apparatus to be described in the present embodiment is used for defect inspection of a surface of a sample (wafer) performed in a manufacturing step of, for example, a semiconductor. The surface inspection apparatus is suitable for performing processing of detecting a minute defect and acquiring data related to a number, a position, a dimension, and a type of a defect at a high speed.

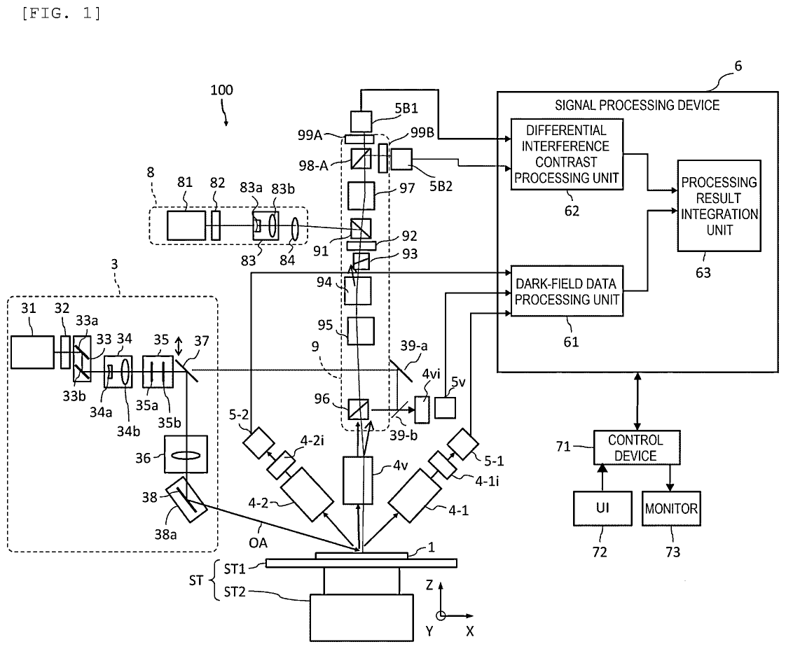

FIG. 1 is a schematic diagram of a configuration example of a surface inspection apparatus according to the present embodiment. A surface inspection apparatus 100 is a surface inspection apparatus that uses a sample 1 as an inspection target and detects a defect such as a foreign substance or a recess on a surface of the sample 1, particularly, a defect of a type depending on an inspection purpose. As the sample 1, a circular plate-shaped semiconductor silicon wafer having a flat surface on which no pattern is formed is assumed as a representative example. The surface inspection apparatus 100 includes, as main components thereof, a stage ST, a dark-field illumination optical system 3, a plurality of detection lenses 4v, 4-1, 4-2, . . . dark-field detection sensors 5v, 1-5, 5-2, . . . , a plurality of image formation lenses 4vi, 4-1i, and 4-21 that form images of light condensed by the detection lenses onto the dark-field detection sensors, line sensors 5B1 and 5B2, a differential interference contrast illumination system 8, a differential interference contrast detection system 9, a signal processing device 6, a control device 71, a user interface 72, and a monitor 73.

### <<Stage ST>>

The stage ST includes a sample table ST1 and a scanning device ST2. The sample table ST1 is a table that supports the sample 1. The scanning device ST2 is a device that drives the sample table ST1 to change relative positions of the sample 1, the dark-field illumination optical system 3, and the differential interference contrast illumination system 8, and includes a translation stage, a rotation stage, and a Z stage that are not shown in detail. Specifically, the rotation stage is supported by the translation stage via the Z stage, and the sample table ST1 is supported by the rotation stage. The translation stage is translated in a horizontal direction together with the rotation stage, and the rotation stage rotates about an axis extending vertically. The Z stage functions to adjust a height of a surface of the sample 1.

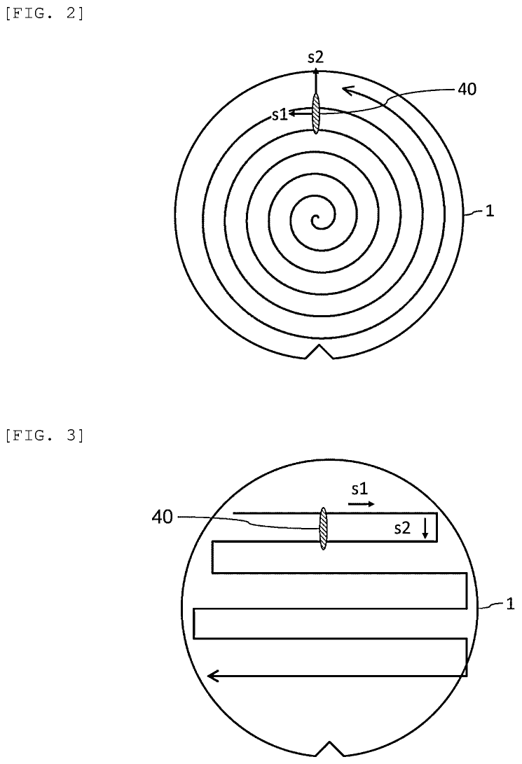

FIG. 2 is a schematic diagram showing a scanning trajectory on the sample 1 by the scanning device ST2. The scanning device ST2 is a scanning unit that scans the surface of the sample 1 with a polarized illumination spot. Although details will be described later, an illumination spot 40 obtained by illuminating the surface of the sample 1 by illumination light emitted from the dark-field illumination optical system 3 has an illumination intensity distribution long in one direction as shown in FIG. 2. A long axis direction of the illumination spot 40 is a direction s2, and a direction intersecting the long axis (here, a short axis direction orthogonal to the long axis) is a direction s1. The sample 1 rotates with the rotation of the rotation stage, the scanning is performed with the illumination spot 40 in the direction s1 relative to the surface of the sample 1, the sample 1 moves in the horizontal direction with the translation of the translation stage, and the scanning is performed with the illumination spot 40 in the direction s2 relative to the surface of the sample 1. When the sample 1 moves while being rotated by an operation of the scanning device ST2, as shown in FIG. 2, the illumination spot 40 moves presenting a spiral trajectory from a center to an outer edge of the sample 1, and the entire surface of the sample 1 is scanned. The illumination spot 40 moves in the direction s2 by a distance equal to or less than a length of the illumination spot 40 in the direction s2 during one rotation of the sample 1. The same applies to an illumination spot formed by the differential interference contrast illumination system 8.

A scanning device having a configuration in which another translation stage whose movement axis extends in a direction intersecting a movement axis of the translation stage in a horizontal plane is provided instead of the rotation stage can also be applied. In this case, as shown in FIG. 3, the surface of the sample 1 is scanned with the illumination spot 40 in a folded linear trajectory instead of the spiral trajectory. Specifically, a first translation stage performs a translational driving in the direction s1 at a constant speed, a second translation stage is driven in the direction s2 by a predetermined distance (for example, a distance equal to or less than the length of the illumination spot 40 in the direction s2), and then the first translation stage turns back in the direction s1 again to be translationally driven. Accordingly, the entire surface of the sample 1 is scanned with the illumination spot 40 by repeating linear scanning in the direction s1 and movement in the direction s2. Compared with this scanning method, the spiral scanning method shown in FIG. 2 does not involve a reciprocating operation, which is advantageous in inspecting the sample 1 in a short time.

### <<Dark-Field Illumination Optical System 3>>

The dark-field illumination optical system 3 shown in FIG. 1 includes an optical element group for illuminating the sample 1 placed on the sample table ST1 with desired illumination light. The dark-field illumination optical system 3 includes a laser light source 31, an attenuator 32, an emission light adjustment unit 33, a beam expander 34, a polarization control unit 35, a light condensing optical unit 36, and reflection mirrors 37 and 38.

### <Laser Light Source 31>

The laser light source 31 is a unit that emits a laser beam as illumination light. When detecting a minute defect in the vicinity of the surface of the sample 1 by the surface inspection apparatus 100, the laser light source 31 is used to oscillate a high-power laser beam that has an output of 2 W or more and is an ultraviolet ray having a short wavelength (wavelength of 355 nm or less) or a vacuum ultraviolet ray that hardly penetrates the sample 1. A diameter of the laser beam emitted from the laser light source 31 is typically about 1 mm. When detecting a defect inside the sample 1 by the surface inspection apparatus 100, the laser light source 31 is used to oscillate a visible or infrared laser beam having a long wavelength and easily penetrating the sample 1.

### <Attenuator 32>

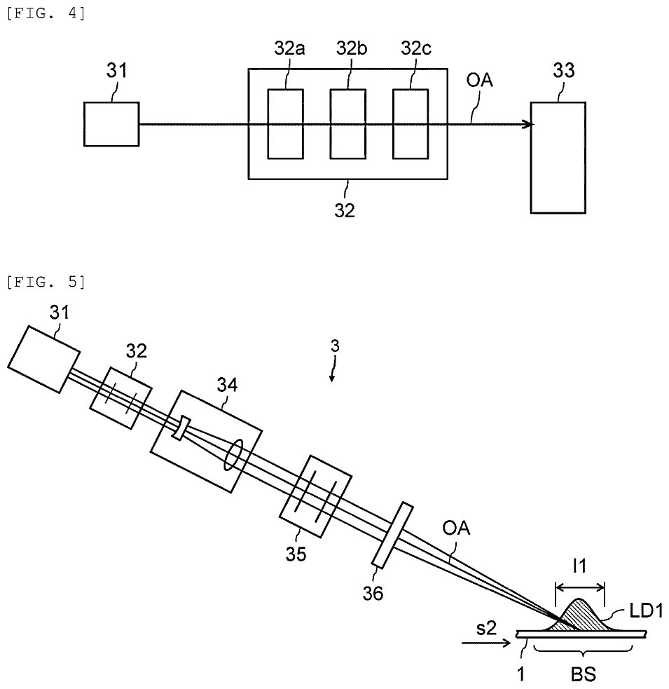

FIG. 4 is a schematic diagram showing the attenuator 32 extracted from the dark-field illumination optical system 3. Here, a configuration example is shown in which the attenuator 32 is a combination of a first polarization plate 32a, a half-wavelength plate 32b, and a second polarization plate 32c. The attenuator 32 is a unit that attenuates a light intensity of the illumination light from the laser light source 31.

The half-wavelength plate 32b is rotatable around an optical axis of the illumination light. The illumination light incident on the attenuator 32 is converted into linearly polarized light by the first polarization plate 32a and then passes through the second polarization plate 32c after a polarization direction thereof is adjusted to a slow axis azimuth angle of the half-wavelength plate 32b. By the azimuth angle adjustment in the half-wavelength plate 32b, the light intensity of the illumination light can be attenuated at any ratio. When a linear polarization degree of the illumination light incident on the attenuator 32 is sufficiently high, the first polarization plate 32a may be omitted. The attenuator 32 is not limited to the configuration shown in FIG. 4, and may be implemented by using an ND filter having a gradation density distribution, specifically, may have a configuration capable of adjusting an attenuation effect by a combination of a plurality of ND filters having different densities.

### <Emission Light Adjustment Unit 33>

The emission light adjustment unit 33 is a unit that adjusts an angle of the optical axis of the illumination light attenuated by the attenuator 32 and includes a plurality of reflection mirrors 33a and 33b in the present embodiment. Although the illumination light is sequentially reflected by the reflection mirrors 33a and 33b, in the present embodiment, an incidence and emission surface of the illumination light with respect to the reflection mirror 33a is orthogonal to an incidence and emission surface of the illumination light with respect to the reflection mirror 33b. The incidence and emission surface is a surface having an optical axis incident on the reflection mirror and an optical axis emitted from the reflection mirror. For example, when a three-dimensional XYZ orthogonal coordinate system is defined and the illumination light is incident on the reflection mirror 33a in a +X direction, the illumination light is deflected by the reflection mirror 33a in a +Y direction and then by the reflection mirror 33b in a +Z direction, which is different from the schematic FIG. 1. In this example, the incidence and emission surface of the illumination light with respect to the reflection mirror 33a is an XY plane, and the incidence and emission surface with respect to the reflection mirror 33b is a YZ plane.

Although not shown, the reflection mirrors 33a and 33b are provided with a mechanism for translating and a mechanism for tilting the reflection mirrors 33a and 33b, respectively. According to these mechanisms, the reflection mirrors 33a and 33b perform a parallel movement in an incident direction or an emission direction of the illumination light with respect to the reflection mirrors 33a and 33b, and tilt around a normal line to the incidence and emission surfaces thereof. Accordingly, for example, with respect to the optical axis of the illumination light emitted from the emission light adjustment unit 33 in the +Z direction, an offset amount and an angle in an XZ plane and an offset amount and an angle in the YZ plane can be independently adjusted. Although a configuration using the two reflection mirrors 33a and 33b is shown in the present example, a configuration using three or more reflection mirrors may be used.

### <Beam Expander 34>

The beam expander 34 is a unit that enlarges a luminous flux diameter of the incident illumination light and includes a plurality of lenses 34a and 34b. An example of the beam expander 34 is a Galileo type using a concave lens as the lens 34a and a convex lens as the lens 34b. The beam expander 34 is provided with an interval adjustment mechanism (zoom mechanism) for the lenses 34a and 34b, and a magnification ratio of the luminous flux diameter is changed by adjusting an interval between the lenses 34a and 34b. The magnification ratio of the luminous flux diameter by the beam expander 34 is about 5 times to 10 times, and in this case, when the beam diameter of the illumination light emitted from the laser light source 31 is 1 mm, a beam system of the illumination light is enlarged to about 5 mm to 10 mm. When the illumination light incident on the beam expander 34 is not a parallel luminous flux, the illumination light can be collimated (quasi-parallelization of the luminous flux) together with the luminous flux diameter by adjusting the interval between the lenses 34a and 34b. However, in collimating the luminous flux, a configuration providing a collimating lens upstream of the beam expander 34 separately from the beam expander 34 may be used.

The beam expander 34 is provided on a translation stage having two or more axes (two or more degrees of freedom), and a position thereof can be adjusted such that a center thereof coincides with that of the incident illumination light. The beam expander 34 also has a tilt angle adjustment function of two or more axes (two or more degrees of freedom) such that an optical axis coincides with that of the incident illumination light.

### <Polarization Control Unit 35>

The polarization control unit 35 is an optical system that controls a polarization state of the illumination light and includes a half-wavelength plate 35a and a quarter-wavelength plate 35b. For example, when performing oblique illumination by placing the reflection mirror 37 to be described later into an optical path, an amount of scattered light from a defect on the surface of the sample 1 increases by setting the illumination light to be P-polarized light by the polarization control unit 35 compared to polarized light other than the P-polarized light. When scattered light (referred to as haze) from minute unevenness on the surface of the sample itself obstructs the detection of a minute defect, the haze (scattered light) can be reduced by setting the illumination light to be the S-polarized light compared to the polarized light other than the S-polarized light. The polarization control unit 35 can also set the illumination light to be circularly polarized light or to be 45° polarized light between the P-polarized light and S-polarized light.

### <Reflection Mirror 37>

The reflection mirror 37 can switch an incident path of the illumination light with respect to the sample 1 by performing a parallel movement in an arrow direction by a drive mechanism (not shown) and entering and exiting the optical path of the illumination light traveling toward the sample 1. By inserting the reflection mirror 37 into the optical path, the illumination light emitted from the polarization control unit 35 is reflected by the reflection mirror 37 and then is obliquely incident on the sample 1 via the light condensing optical unit 36 and the reflection mirror 38. In contrast, when the reflection mirror 37 is removed from the optical path, the illumination light emitted from the polarization control unit 35 is perpendicularly incident on the sample 1 via an optical unit (not shown).

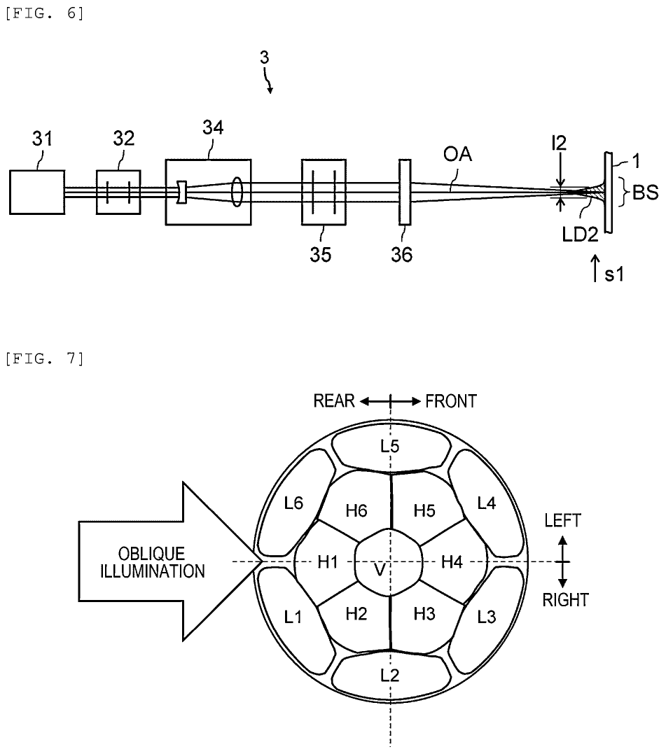

FIGS. 5 and 6 are schematic diagrams showing positional relationships between the optical axis of the illumination light guided to the surface of the sample 1 from an oblique direction by the dark-field illumination optical system 3 and an illumination intensity distribution shape. FIG. 5 schematically shows a cross-section of the sample 1 taken along an incidence surface of the illumination light incident on the sample 1. FIG. 6 schematically shows a cross-section of the sample 1 taken along a surface that is orthogonal to the incidence surface of the illumination light incident on the sample 1 and that has a normal line of the surface of the sample 1. Here, the incidence surface is a surface having an optical axis OA of the illumination light incident on the sample 1 and the normal line of the surface of the sample 1. In FIGS. 5 and 6, a part of the dark-field illumination optical system 3 is extracted and shown, and for example, the emission light adjustment unit 33 and the reflection mirror 37 are not shown.

As shown in FIG. 1, when the reflection mirror 37 is inserted into the optical path, the illumination light emitted from the laser light source 31 is condensed by the light condensing optical unit 36, is reflected by the reflection mirror 38, and is obliquely incident on the sample 1. In this way, the dark-field illumination optical system 3 is configured to allow the illumination light to be incident on the sample 1 from a direction inclined with respect to the normal line of the surface of the sample 1 (oblique illumination). In the oblique illumination, the light intensity is adjusted by the attenuator 32, the luminous flux diameter is adjusted by the beam expander 34, and the polarization is adjusted by the polarization control unit 35, thereby making an illumination intensity distribution uniform in the incidence surface. As in an illumination intensity distribution (illumination profile) LD1 shown in FIG. 5, the illumination spot formed on the sample 1 has a Gaussian light intensity distribution in the direction s2, and a length of a beam width 11 defined by 13.5% of a peak is, for example, about 25 μm to 4 mm.

In a plane orthogonal to the incidence surface and the sample surface, the illumination spot has a light intensity distribution in which the intensity in the periphery is weak relative to that at a center of the optical axis OA as in an illumination intensity distribution (illumination profile) LD2 shown in FIG. 6. Specifically, the light intensity distribution is, for example, the Gaussian distribution reflecting the intensity distribution of the light incident on the light condensing optical unit 36 or an intensity distribution similar to a Bessel function of the first kind or a sinc function reflecting an opening shape of the light condensing optical unit 36. A length 12 of the illumination intensity distribution in the surface orthogonal to the incidence surface and the sample surface is set to be shorter than the beam width 11 shown in FIG. 5, for example, about 1.0 μm to 20 μm to reduce the haze (scattered light) generated from the surface of the sample 1. The length 12 of the illumination intensity distribution is a length of a region having an illumination intensity of 13.5% or more of a maximum illumination intensity in the surface orthogonal to the incidence surface and the sample surface.

An incident angle (a tilt angle of an incidence optical axis with respect to the normal line of the sample surface) of the illumination light obliquely incident on the sample 1 with respect to the sample 1 is adjusted to an angle suitable for detecting a minute defect by positions and angles of the reflection mirrors 37 and 38. The angle of the reflection mirror 38 is adjusted by an adjustment mechanism 38a. For example, the larger the incident angle of the illumination light with respect to the sample 1 (the smaller an illumination elevation angle that is an angle formed by the sample surface and the incident optical axis) is, the weaker the haze that becomes noise with respect to the scattered light from a minute foreign substance on the sample surface is, making it suitable for detecting a minute defect. From a viewpoint of reducing the influence of the haze on the detection of the minute defect, the incident angle of the illumination light is preferably set to, for example, 75 degrees or more (elevation angle of 15 degrees or less). On the other hand, since an absolute amount of the scattered light from the minute foreign substance increases as the illumination incident angle decreases, the incident angle of the illumination light is preferably set to, for example, 60 degrees or more and 75 degrees or less (the elevation angle of 15 degrees or more and 30 degrees or less) from a viewpoint of aiming at an increase in the amount of the scattered light from the defect.

When the reflection mirror 37 is removed from the optical path, the light emitted from the laser light source 31 forms an illumination spot of epi-illumination on the sample surface via mirrors 39-a and 39-b, a dichroic mirror 96, and the detection lens 4v. The mirrors 39-a and 39-b are referred to as an epi-illumination optical system. Also in the epi-illumination, the illumination intensity distribution is set to be the same as that of the above-described oblique illumination. The mirror 39-b is a bar-shaped mirror. FIG. 16 shows an arrangement diagram of the mirror 39-b and the image formation lens 4vi from an X-axis direction shown in FIG. 1. The illumination light from the laser light source 31 reflected by the reflection mirror 39-a is emitted perpendicularly to the sample surface via the bar-shaped mirror 39-b. In contrast, reflected light and directly reflected light from the sample surface are cut by the bar-shaped mirror 39-b, and the other light passes through a region that is not shielded by the bar-shaped mirror 39-b and is guided to the image formation lens 4vi in a subsequent stage.

### <<Detection Optical System>>

The detection lenses 4v, 4-1, 4-2, . . . are lenses (objective lenses) that condense illumination scattered-light from the sample surface. An example will be described in which the surface inspection apparatus 100 includes 13 detection optical systems.

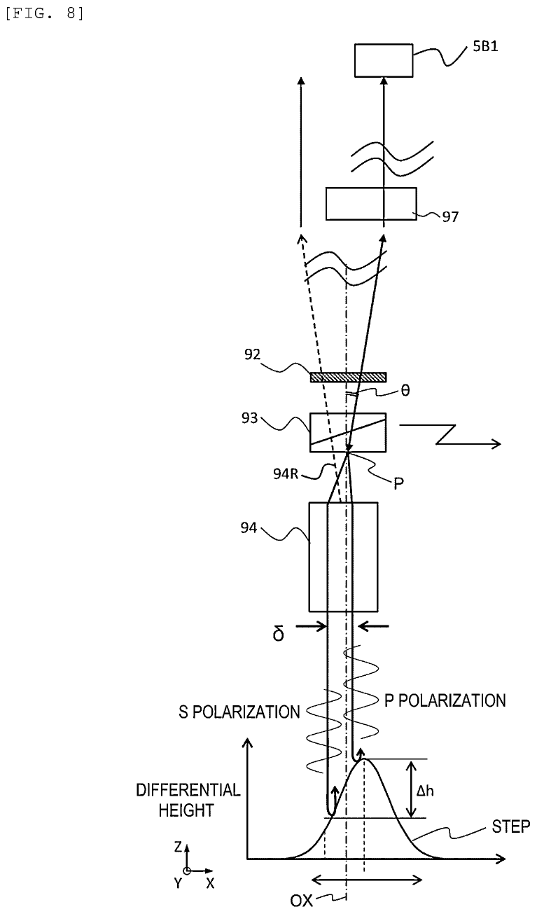

FIG. 7 is a top view of regions in which the detection lenses 4v, 4-1, 4-2, . . . capture the scattered light, and the regions correspond to an arrangement of the objective lenses of the detection lenses 4v, 4-1, 4-2, . . . . In the following description, with reference to the incident direction in the oblique illumination on the sample 1, when viewed from above, a traveling direction (right direction in FIG. 7) of the incident light with respect to the illumination spot 40 on the surface of the sample 1 is referred to as a front side, and an opposite direction (left direction in FIG. 7) is referred to as a rear side. Therefore, the lower side in FIG. 7 is the right side and the upper side is the left side with respect to the illumination spot 40.

The detection lenses 4v, 4-1, 4-2, . . . are arranged along an upper hemispherical surface of a sphere (celestial sphere) centered on the illumination spot 40 with respect to the sample 1. The hemispherical surface is divided into 13 regions including regions L1 to L6, H1 to H6, and V, and the detection lenses 4v, 4-1, 4-2, . . . capture and condense the scattered light in the corresponding regions.

The region V is a region overlapping the zenith and is located directly above the illumination spot 40 formed on the surface of the sample 1. The detection lens 4v corresponds to the region V.

The regions L1 to L6 are regions obtained by equally dividing an annular region surrounding 360 degrees around the illumination spot 40 at a low position and are arranged in an order of the regions L1, L2, L3, L4, L5, and L6 counterclockwise from the incident direction in the oblique illumination. The regions L1 to L3 among the regions L1 to L6 are located on the right side with respect to the illumination spot 40. The region L1 is located at the right rear side of the illumination spot 40. The region L2 is located on the right side of the illumination spot 40, and the region L3 is located on the right front side of the illumination spot 40. The regions L4 to L6 are located on the left side with respect to the illumination spot 40. The region L4 is located on the left front side of the illumination spot 40. The region L5 is located on the left side of the illumination spot 40. The region L6 is located on the left rear side of the illumination spot 40.

Regions H1 to H6 are regions obtained by equally dividing an annular region surrounding 360 degrees around the illumination spot 40 at a high position (between the regions L1 to L6 and the region V) and are arranged in an order of the regions H1, H2, H3, H4, H5, and H6 counterclockwise from the incident direction in the oblique illumination when viewed from above. The arrangement of the high-angle regions H1 to H6 is shifted by 30 degrees from the low-angle regions L1 to L6 when viewed from above.

The region H1 among the regions H1 to H6 is located on the rear side with respect to the illumination spot 40. The region H4 is located on the front side with respect to the illumination spot 40. The regions H2 and H3 are located on the right side with respect to the illumination spot 40. The region H2 is located on the right rear side with respect to the illumination spot 40. The region H3 is located on the right front side with respect to the illumination spot 40. The regions H5 and H6 are located on the left side with respect to the illumination spot 40. The region H5 is located on the left front side with respect to the illumination spot 40. The region H6 is located on the left rear side with respect to the illumination spot 40.

The scattered light incident on the detection lenses 4v, 4-1, 4-2, . . . are condensed, are image-formed by the corresponding image formation lenses 4vi, 4-1i, 4-2i, . . . , and are guided to the dark-field detection sensors 5v, 1-5, 5-2, When FIG. 1 is compared with FIG. 7, for example, the detection lens 4-1 in FIG. 1 is an optical system that captures the scattered light in the region L4 in FIG. 7. The detection lens 4-2 is an optical system that captures the scattered light in the region L6. The detection lens 4v can be associated with, for example, an optical system that captures the scattered light in the region V. As described above, the mirror 39-b provided between the dichroic mirror 96 and the image formation lens 4vi has a bar shape and shields only a part of an optical path between the detection lens 4v and the image formation lens 4vi. Direct reflection from the sample surface is cut by the bar-shaped mirror 39-b, and the light passing through a space that is not shielded by the bar-shaped mirror 39-b is detected by the dark-field detection sensor 5v with the image formation lens 4vi.

The detection lens 4v detects the light from the illumination spot 40 formed by the dark-field illumination optical system 3 and also functions as a relay optical system for detecting the spot formed by the differential interference contrast illumination system 8 and a reflected light thereof by the differential interference contrast detection system 9. That is, the detection lens 4v captures light detected by the line sensors 5B1 and 5B2 for the differential interference contrast measurement in addition to the light detected by the dark-field detection sensor 5v. Therefore, the detection lens 4v is coated with an antireflection film that copes with wavelengths of both the laser light sources 31 and 81.

### <<Dark-Field Detection Sensor 5, Line Sensor 5B>>

The dark-field detection sensors 5v, 5-1, 5-2, . . . are sensors that convert the illumination scattered-light condensed by the corresponding detection lenses 4v, 4-1, 4-2, . . . into electric signals and output detection signals. To photoelectrically convert a weak signal at a high gain, for example, a photomultiplier or a silicon photomultiplier (SiPM) can be used. The dark-field detection sensors 5v, 5-1, 5-2, . . . use point sensors. Instead of the point sensor, a line sensor, an area sensor, or a multi-line sensor implemented by a plurality of line sensors may be used. The dark-field detection sensors 5v, 5-1, 5-2, . . . correspond to the detection lenses 4v, 4-1, 4-2, . . . The dark-field detection sensor 5v detects the illumination scattered-light via the dichroic mirror 96. Wavelength characteristics of the dichroic mirror 96 will be described later.

The line sensors 5B1 and 5B2 are sensor units that photoelectrically convert interference light generated by the differential interference contrast detection system 9 to generate interference signals. Since the line sensors 5B1 and 5B2 directly detect the reflected light, there is little need to have a high gain as compared with the dark-field detection sensors 5v, 5-1, 5-2, . . . , and a photodiode sensor or an avalanche photodiode sensor can be used. Although a line sensor is used in the present embodiment, a point sensor, an area sensor, or a multiline sensor may be used similarly to the dark-field detection sensors 5v, 5-1, 5-2, . . . . As a sensor type, a photomultiplier, a SiPM, a CMOS sensor, or a CCD can be used. The detection signals output from the dark-field detection sensors 5v, 5-1, 5-2, . . . are input to a dark-field data processing unit 61 of the signal processing device 6. The detection signals (interference signals) output from the line sensors 5B1 and 5B2 are input to a differential interference contrast processing unit 62 of the signal processing device 6.

### <<Differential Interference Contrast Illumination System 8>>

The differential interference contrast illumination system 8 includes the laser light source 81, an attenuator 82, a beam shaping unit 83, and a lens 84. The differential interference contrast illumination system 8 irradiates the sample from a vertical direction with the illumination light for detecting the differential interference contrast and irradiates the sample surface with an illumination spot set including two polarized illumination spots that have different phases at a predetermined wavelength and that are shifted by a predetermined shear amount.

The laser light source 81 is a unit that emits a laser beam as the illumination light for detecting the differential interference contrast. To measure the differential interference contrast without being affected by the laser light source 31, a wavelength different from the wavelength of the laser light source 31, typically a wavelength larger than 400 nm is used.

The attenuator 82 has the same configuration as that of the attenuator 32 of the dark-field illumination optical system 3 and is a unit that attenuates a light intensity of emission light of the laser light source 81.

The beam shaping unit 83 is an optical system for shaping a beam spot in a dark-field illumination system into a beam having a long axis in the direction s2 similar to the illumination spot 40 shown in FIG. 2. The beam shaping unit 83 includes a plurality of lenses 83a and 83b. The beam shaping unit 83 can be implemented by using a Galileo-type beam expander using a concave lens as the lens 83a and a convex lens as the lens 83b. An anamorphic prism may be used instead of the beam expander, or a combination of both may be used.

The lens 84 forms a beam spot of a desired magnification on a sample 1 side of a differential interference contrast objective lens 94 to be described later together with the differential interference contrast objective lens 94. A focal length of the lens 84 is set to a be larger than focal length of the differential interference contrast objective lens 94, and a spot that is smaller than the illumination spot 40 and that is emitted from the laser light source 81 is formed on the surface of the sample 1. A position of the lens 84 can be adjusted in a surface orthogonal to an optical axis by a stage (not shown). Light incident on the lens 84 from the beam shaping unit 83 is set so as not to pass through a lens center by shifting the position of the lens 84 by the stage. In this case, the light emitted from the lens 84 is inclined from the optical axis.

### <<Differential Interference Contrast Detection System 9>>

The differential interference contrast detection system 9 includes a half beam splitter 91, a quarter-wavelength plate 92, a Nomarski prism 93, the differential interference contrast objective lens 94, a lens 95, the dichroic mirror 96, an image formation lens 97, a half beam splitter 98-A, and polarization filters 99A and 99B. The differential interference contrast detection system 9 detects the differential interference contrast to calculate a height of the sample surface and generates an image of the interference light by condensing the reflected light of the two polarized illumination spots from the sample surface.

The light passing through the lens 84 of the differential interference contrast illumination system 8 is guided to the beam splitter 91. The light passing through the lens 84 is linearly polarized light with an electric field oscillating in a Y direction shown in FIG. 1. The light emitted from the beam splitter 91 is incident on the quarter-wavelength plate 92. The quarter-wavelength plate 92 is provided such that a phase advancing axis is at an angle of 45° with respect to an incident polarization direction. At this time, the light emitted from the quarter-wavelength plate 92 is circularly polarized light.

The Nomarski prism 93 is made of an optical material having birefringence and separates an incident light of circularly polarized light into two linearly polarized light having vibration surfaces orthogonal to each other.

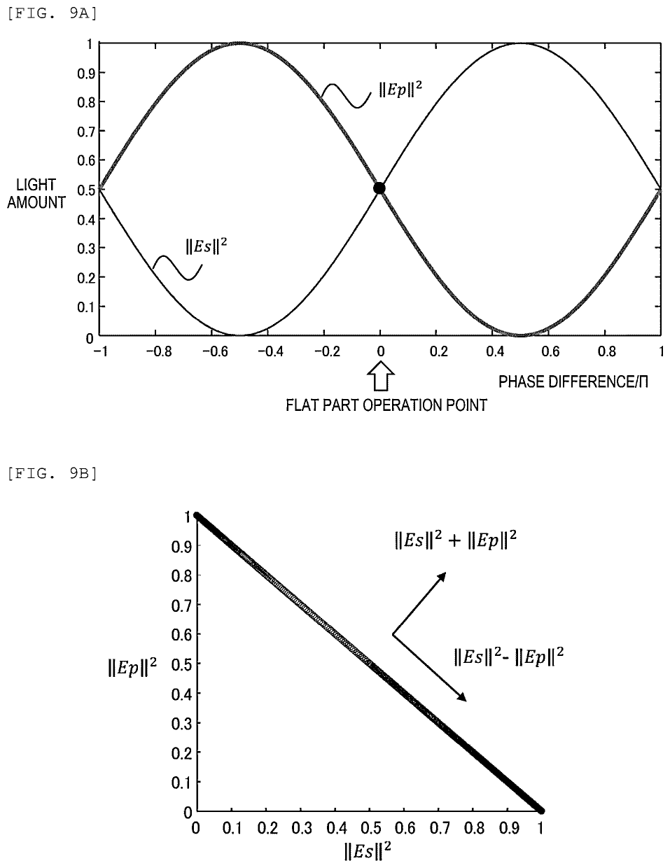

The polarization separation by the Nomarski prism 93 will be described with reference to FIG. 8. The incident light from the differential interference contrast illumination system 8 is incident at an angle of θ with respect to an optical axis OX of the differential interference contrast objective lens 94 by a shift of the lens 84. The Nomarski prism 93 can set a position P at which the incident light is separated into light having two polarized components outside a prism. By matching the separation position P with the pupil position of the objective lens 94, the objective lens 94 forms beam spots in two polarization directions. The beam spot has a linear shape, and in FIG. 8, an X direction is a short diameter and a Y direction is a long diameter. The Nomarski prism 93 can be moved in the X direction by a drive mechanism (not shown) and can adjust a phase difference between the two separated beam spots to a desired magnitude by adjusting the position of the Nomarski prism 93 in the X direction.

The differential interference contrast objective lens 94 is mounted on a stage (not shown), and the objective lens 94 is shifted such that the pupil position thereof matches the separation position P of the Nomarski prism 93. At this time, a center of a luminous flux emitted from the lens 84 intersects the optical axis OX of the objective lens 94 at a rear side focal position of the objective lens 94, and a luminous flux center of the illumination light passing through the objective lens 94 is deviated by an amount of the shift of the objective lens 94 in a direction orthogonal to the optical axis OX.

The light having two polarized components passing through the differential interference contrast objective lens 94 travels almost in parallel. Although not shown in FIG. 8, the surface of the sample 1 is then irradiated with the beam spots in two polarization directions via the lens 95, the detection lens 4v, and the like. When there is a step between positions irradiated with the beam spots, a phase changes between the two polarized lights. A positional deviation amount between the two beam spots is referred to as a shear amount 8. In the differential interference contrast measurement, a step Δh is measured based on a change in phase of the light having two polarized components reflected by the surface of the sample 1.

To implement the high sensitivity in the differential interference contrast measurement, it is necessary to minimize the stray light. It is particularly necessary to pay attention to back surface reflected light 94R from the objective lens 94. The reflected light from the sample surface is collimated by the objective lens 94 and travels to the image formation lens 97. The back surface reflection from the objective lens also interferes with the reflected light from the sample surface and causes a measurement error by being condensed by the image formation lens 97 and reaching a sensor surface. To prevent this measurement error, in the present embodiment, the illumination light is incident on the objective lens 94 at the angle θ with respect to the optical axis OX. Accordingly, the traveling direction of the back surface reflected light 94R from the objective lens 94 is approximately at an angle of 2θ with respect to the traveling direction of the reflected light from the sample surface, thereby separating the reflected light from the sample surface and the stray light. Here, it is required that an image of the stray light deviates with respect to an image of the reflected light in a direction orthogonal to an arrangement of pixels in light reception units of the line sensors 5B1 and 5B2 by shifting by the angle θ in the XZ plane. In the case of FIG. 8, the arrangement of the pixels in the sensor is in the Y direction, and the light reception unit of the sensor in the X direction orthogonal to the Y direction is short. Therefore, the reflected light from the sample surface and the stray light can be separated even with a relatively small inclination angle θ.

Returning to FIG. 1, the description will be continued. The lens 95 of the differential interference contrast detection system 9 forms, together with the detection lens 4v, the two beam spots on the sample 1 deviated by the shear amount in the direction s1. Specifically, the lens 95 condenses an image of the two beam spots formed by the objective lens 94, and the detection lens 4v projects the images onto the surface of the sample 1. The center of the luminous flux incident on the lens 95 is shifted by a shift amount of the objective lens 94 with respect to the optical axis of the lens 95. Accordingly, the luminous flux of the beam spot passing through the lens 95 is inclined with respect to the optical axis. When the optical axes of the detection lens 4v and the objective lens 94 match optically by adjusting the focal position of the lens 95 on the sample surface side to match the rear side focal position of the detection lens 4v, the light emitted from the detection lens 4v travels in parallel with respect to the optical axis of the detection lens 4v and is emitted on the sample surface vertically.

Since the detection lens 4v performs condensing and detection for illumination with a plurality of wavelengths, the lens surface is coated with an antireflection film that copes with the plurality of wavelengths, but it is generally difficult to perform sufficient antireflection with the antireflection of wavelengths, film of a plurality According to the configuration of the differential interference contrast detection system 9 of the present embodiment, the luminous flux of the beam spot is incident on the detection lens 4v while being inclined with respect to the optical axis of the detection lens 4v. Similar to the prevention of the back surface reflection of the illumination incident of the objective lens 94, the generation of the interference noise on a light reception surface of the sensor 5B due to the stray light is prevented by causing the illumination light to be obliquely incident on.

The dichroic mirror 96 between the detection lens 4v and the lens 95 has a characteristic of transmitting the light having a wavelength emitted from the laser light source 81 of the differential interference contrast illumination system 8 and reflecting the light having a wavelength emitted from the laser light source 31 of the dark-field illumination optical system 3 and thus excludes the scattered light in light for dark-field illumination from the differential interference contrast detection system 9. The light excluded from the differential interference contrast detection system 9 by the dichroic mirror 96 is detected by the dark-field detection sensor 5v with the image formation lens 4vi. Since the dichroic mirror 96 has a characteristic of transmitting the light emitted from the laser light source 81, the illumination and the detection for the differential interference contrast are not affected.

When the light captured by the differential interference contrast objective lens 94 in two polarization directions in which vibration surfaces are orthogonal to each other passes through the Nomarski prism 93, the direction of the light changes due to characteristics of a birefringence material, and the light returns to the same light (interference light).

The interference light emitted from the Nomarski prism 93 passes through the quarter-wavelength plate 92, passes through the beam splitter 91 and the image formation lens 97, and optical path split is performed by the half beam splitter 98-A. The polarization filters 99A and 99B are disposed on the split optical paths, and the line sensors 5B1 and 5B2 detect interference light in a specific polarization direction. Each of the polarization filters 99A and 99B includes a rotation stage (not shown) and can set a polarization direction to be output to each of the line sensors 5B1 and 5B2.

Here, the polarization direction of the back surface reflected light 94R from the objective lens 94 will be described as an example of the interference noise. First, assuming that there is no phase difference between the reflected light from the positions irradiated with the two beam spots, at this time, the polarization direction of the interference light after the light emitted from the Nomarski prism 93 passes through the quarter-wavelength plate 92 is considered. Using the Jones matrix, the quarter-wavelength plate can be expressed as in (Formula 1).

$$[ Formula 1 ]$$

$$QWP 45 = [ \begin{matrix}cos π / 4 & - sin π / 4 \\ sin π / 4 & cos π / 4\end{matrix} ] [ \begin{matrix}1 & 0 \\ 0 & i\end{matrix} ] [ \begin{matrix}cos π / 4 & sin π / 4 \\ - sin π / 4 & cos π / 4\end{matrix} ] \qquad ( 1 )$$

The Nomarski prism 93 performs adjustment to generate a phase deviation of ⅛ wavelength in a polarization direction in which an amplitude direction of an electric field is the Y direction shown in FIG. 8 with respect to a polarization direction in which an amplitude direction of an electric field is the X direction. At this time, the Nomarski prism can be expressed as in (Formula 2).

$$[ Formula 2 ]$$

$$NP = [ \begin{matrix}1 & 0 \\ 0 & exp i π / 4\end{matrix} ] \qquad ( 2 )$$

When the sample surface is scanned at a high speed as shown in FIG. 2 or FIG. 3, even when the sample surface is flat, a work distance between the differential interference contrast detection system 9 and the sample surface is displaced in a nanometer order due to vibration, eccentricity, or the like of the rotation stage. When the height displacement of the sample surface at this time is Z, a displacement of a differential distance can be expressed as in (Formula 3).

$$[ Formula 3 ]$$

$$material ( Z ) = exp ( - \frac{4 i π Z}{λ} ) [ \begin{matrix}1 & 0 \\ 0 & 1\end{matrix} ] \qquad ( 3 )$$

The light incident on the quarter-wavelength plate 92 is polarized light whose amplitude direction of the electric field is the Y direction shown in FIG. 8. At this time, the polarization of the interference light that interferes with the reflected light from the sample 1 can be expressed by (Formula 4).

$$[ Formula 4 ]$$

$$[ \begin{matrix}{flat}_{s} \\ {flat}_{p}\end{matrix} ] = \text{} QWP 45 \cdot NP \cdot material ( Z ) \cdot NP \cdot QWP 45 [ \begin{matrix}0 \\ 1\end{matrix} ] = exp ( - \frac{4 i π Z}{λ} ) [ \begin{matrix}- 0.5 & - 0.5 i \\ - 0.5 & - 0.5 i\end{matrix} ] \qquad ( 4 )$$

In this way, the polarization of the interference light due to the reflected light from the sample surface becomes linear polarization rotated by 45 degrees with respect to the polarization direction of the illumination light incident on the quarter-wavelength plate 92. Meanwhile, since the back surface reflected light 94R from the objective lens 94, which becomes the stray light, similarly passes through the quarter-wavelength plate 92 twice and passes through the Nomarski prism 93 twice, the back surface reflected light 94R becomes the linearly polarized light rotated by 45 degrees and can be expressed similarly to (Formula 4). When the reflectance from the objective lens 94 is represented by R and the optical path change due to the lens reflection is represented by N, the polarization of the back surface reflected light 94R can be expressed as in (Formula 5).

$$[ Formula 5 ]$$

$$[ \begin{matrix}{Noise}_{s} \\ {Noise}_{p}\end{matrix} ] = \text{} QWP 45 \cdot NP \cdot Noise \cdot NP \cdot QWP 45 [ \begin{matrix}0 \\ R\end{matrix} ] = R exp ( - \frac{4 i π N}{λ} ) [ \begin{matrix}- 0.5 & - 0.5 i \\ - 0.5 & - 0.5 i\end{matrix} ] \qquad ( 5 )$$

As described above, in the present embodiment, the illumination light is incident at the angle θ with respect to the optical axis OX of the objective lens 94 of the differential interference contrast detection system 9, thereby excluding the back surface reflected light 94R. However, when the back surface reflected light 94R cannot be completely excluded from the light reception unit of the sensor 5B, or when the illumination light is incident along the optical axis OX of the objective lens 94, an amount of light detected by the sensor 5B is a sum of (Formula 4) and (Formula 5). It can be seen that the detected amount of light including the stray light is linear polarization rotated by 45 degrees, and interference with the back surface reflected light 94R is caused by the height displacement of the sample surface. Although the back surface reflected light 94R from the objective lens 94 has been described here, the same applies to the back surface reflected light from the detection lens 4v.

In contrast, a case in which the sample surface is not flat is considered. It is assumed that an optical path difference of Δh occurs between two spots separated by the shear amount. Here, noise is not considered. In this case, the polarization of the interference light due to the reflected light from the sample surface can be expressed as (Formula 6).

$$[ Formula 6 ]$$

$$[ \begin{matrix}{E}_{s} \\ {E}_{p}\end{matrix} ] = exp ( - \frac{4 i π Z}{λ} ) QWP 45 \cdot NP [ \begin{matrix}1 & 0 \\ 0 & exp - \frac{4 i πΔ h}{λ}\end{matrix} ] NP \cdot QWP 45 [ \begin{matrix}0 \\ 1\end{matrix} ] = - 0.5 exp ( - \frac{4 i π Z}{λ} ) [ \begin{matrix}i exp - \frac{4 i πΔ h}{λ} + 1 \\ exp - \frac{4 i πΔ h}{λ} + i\end{matrix} ] \qquad ( 6 )$$

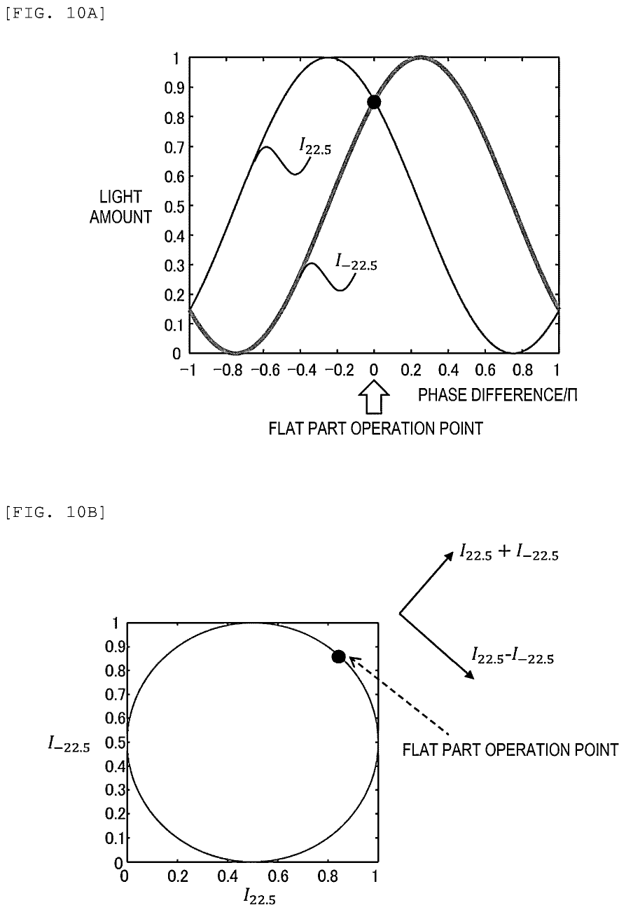

FIG. 9A shows a calculation result obtained by converting an S-polarized component (polarization in which the amplitude direction of the electric field is the X direction shown in FIG. 8) Es and a P-polarized component (polarization in which the amplitude direction of the electric field is the Y direction shown in FIG. 8) Ep into a light amount. A vertical axis represents a converted light amount, and a horizontal axis represents a phase difference (phase difference/II) between the S-deflected component and the P-polarized component. However, the converted light amount of the vertical axis is shown as values normalized by an interference signal maximum detection light amount I to be described later. In this way, the light amount Es of the S-polarized component and the light amount Ep of the P-polarized component oscillate as the Δh changes. When the phase difference between the beam spots is 0, which means the Δh is 0, the light amount Es of the S-polarized component and the light amount Ep of the P-polarized component are equal.

A scatter diagram is FIG. 9B. It can be seen that ∥Es∥²+∥Ep∥² is constant regardless of the change in Δh, and the change in Δh is manifested in ∥Es∥²−∥Ep∥². Here, the influence of the noise due to the stray light is considered. When the sample surface is flat (Δh=0), as shown in (Formula 5), in the stray light, both an S-polarized component Noises and a P-polarized component Noiseₚ are linear polarization having the same amplitude rotated by 45 degrees with respect to the incident light. Therefore, even when the S-polarized component Es and the P-polarized component Ep contain noise due to the stray light, interference between the stray light and the reflected light from the sample surface to be detected is canceled from a value of ∥Es∥²−∥Ep∥² at a flat part operation point at which there is no phase difference between the beam spots. To manifest a defect having a low step, it is desirable that the sensitivity is highest in the vicinity of the flat part operation point. The sensitivity of the differential interference contrast measurement can be improved by canceling the influence due to the stray light at the flat part operation point. However, since the scatter diagram shown in FIG. 9B is a straight line, the light amount that is uniquely determined corresponding to the phase is in a range of ±0.5 π.

In the differential interference contrast detection system 9 according to the present embodiment, a setting for canceling the stray light at the flat part operation point is performed by adjusting the polarization filters 99A and 99B. Specifically, by setting a transmission polarization direction of the polarization filter to be symmetrical with respect to the polarization direction of the interference light due to the reflected light from the flat sample surface (Δh=0), it is possible to cancel the interference between the stray light and the interference light due to the reflected light from the sample surface to be detected from the value of ∥Es∥²−∥Ep∥² having sensitivity to the change in Δh at the flat part operation point.

Since the interference light due to the reflected light from the sample surface and transmitted through the quarter-wavelength plate 92 is the linearly polarized light, the polarization direction thereof is θᵣ. The optical path difference Δh between the two spots is reflected in the polarization direction θᵣ, and the optical path difference Δh can be obtained from the polarization direction θᵣ. As shown in (Formula 4), when the Nomarski prism 93 generates a phase difference of a ⅛ wavelength, in the reflected light from the flat sample surface, the polarization direction of the interference light due to the reflected light from the flat sample surface is at an angle of 45 degrees with respect to the incident light. Therefore, the transmission polarization directions of the polarization filters 99A and 99B are set to (45±α) degrees. Since an ideal flat sample surface does not exist in an actual machine, the phase difference of the Nomarski prism 93 is adjusted such that the polarization direction of the interference light due to the reflected light from the sample surface defined as the flat sample surface is at an angle of 45 degrees with respect to the incident light.

For example, when the transmission polarization direction of the polarization filter 99A is set to (45+α) degrees and the transmission polarization direction of the polarization filter 99B is set to (45−α) degrees, light amounts I_{α} and I_{-α} obtained by the line sensors 5B1 and 5B2 are respectively expressed by (Formula 7) and (Formula 8), respectively. Specifically, the light amounts obtained by the line sensors 5B1 and 5B2 are intensities of interference signals generated by photoelectrically converting the light received by the line sensors 5B1 and 5B2.

$$[ Formula 7 ]$$

$${I}_{α} = I {cos}^{2} ( {θ}_{r} + 45 + α ) \qquad ( 7 )$$

$$[ Formula 8 ]$$

$${I}_{- α} = I {cos}^{2} ( {θ}_{r} + 45 - α ) \qquad ( 8 )$$

Here, I is a detection light amount obtained when the transmission polarization direction is set in the split optical path to maximize the light amount and is referred to as the interference signal maximum detection light amount. When assuming that the interference light is detected by a single sensor whose polarization direction in which the detection is to be performed is equal to the polarization direction of the interference light, the interference signal maximum detection light amount I corresponds to an intensity of an interference signal obtained by photoelectrically converting the interference light received by the single sensor. From (Formula 7) and (Formula 8), (Formula 9) and (Formula 10) are obtained.

$$[ Formula 9 ]$$

$${I}_{α} + {I}_{- α} = I ( 1 - sin 2 {θ}_{r} cos 2 α ) \qquad ( 9 )$$

$$[ Formula 10 ]$$

$${I}_{a} - {I}_{- a} = - I ( cos 2 {θ}_{r} sin 2 α ) \qquad ( 10 )$$

In (Formula 10), since the light amounts I_{α} and I_{-α} have the same sensitivity in the polarization direction of the stray light rotated by 45 degrees, the influence of the interference noise due to the stray light is canceled from a difference (I_{α}−I_{-α}) at the flat surface operation point.

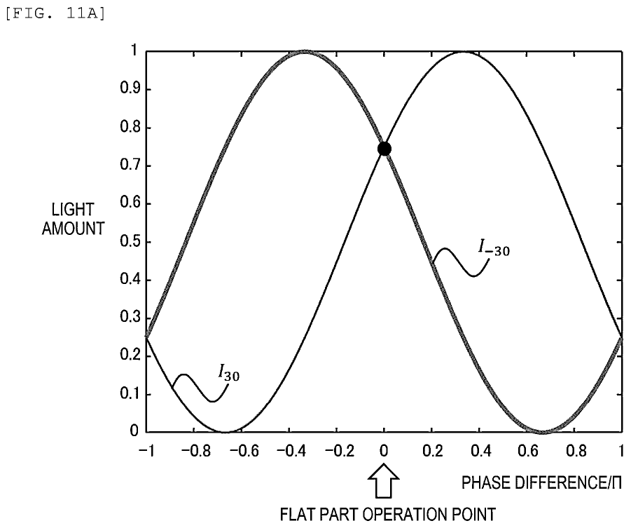

FIGS. 10A and 10B show calculation results of the light amounts I_{α} and I_{-α} when α is set to 22.5 degrees. FIG. 10A shows the light amounts I_{α} and I_{-α} obtained when the phase difference between the two spots is shifted in a range of ±π, and FIG. 10B is a scatter diagram of the light amounts I_{α} and I_{-α}. In FIG. 9B, the light amount that is uniquely determined corresponding to the phase is obtained in a range of ±0.5 π, whereas as the scatter diagram in FIG. 10B draws an arc, in this case, the light amount can be uniquely determined up to ±π, and a dynamic range of the phase calculation can be improved.

In FIG. 10A, a position at which the phase difference on a horizontal axis is 0 is in a state in which there is no height displacement between the two polarized beam spots (Δh=0), and is a portion (flat part operation point) at which the sensitivity needs to be highest to manifest a defect having a low step. Therefore, the detection sensitivity is improved by canceling the influence due to the stray light at the flat part operation point. At the flat part operation point, as shown in FIG. 10A, the light amounts I_{α} and I_{-α} have the same signal intensity, and as can be seen from the flat part operation point shown in FIG. 10B, a value of (I_{α}+I_{-α}) is maximum and therefore the most stable detection can be performed.

From (Formula 9) and (Formula 10), the interference signal maximum detection light amount I can be obtained by (Formula 11).

$$[ Formula 11 ]$$

$$I = \frac{( {I}_{a} + {I}_{- α} ) \pm cos 2 {α ( {( {I}_{α} + {I}_{- a} )}^{2} - {( {I}_{α} - {I}_{- a} )}^{2} )}^{0.5}}{{sin}^{2} 2 α} \qquad ( 11 )$$

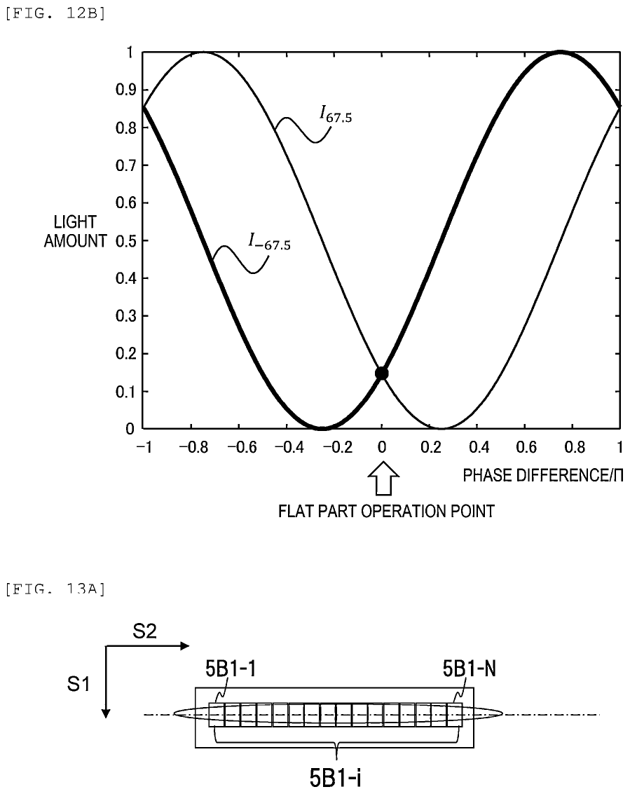

FIG. 12A shows a result of estimating the interference signal maximum detection light amount I by substituting (I_{α}+I_{-α}) and (I_{α}−I_{-α}) into (Formula 11). (I_{α}+I_{-α}) at the flat part operation point exceeds a value of the interference signal maximum detection light amount I, and by increasing a ratio between (I_{α}+I_{-α}) and the stray light, an estimation error of the interference signal maximum detection light amount I caused by the stray light can be reduced. In addition, in (Formula 11), two solutions may be calculated, and it is possible to select a more appropriate solution by comparison with an expected value because a detection light amount that can be expected can be predicted in a typical usage method. For example, in the example in FIG. 10A, there are operation points other than the flat part operation point at which the light amounts I_{α} and I_{-α} have the same signal intensity, and the interference signal maximum detection light amount I estimated at the operation points other than the flat part operation point is different from the interference signal maximum detection light amount I estimated at the flat part operation point. Therefore, the predicted interference signal maximum detection light amount I is stored in advance in a storage device of the signal processing device 6, and when a plurality of interference signal maximum detection light amount candidates are calculated, the differential interference contrast processing unit 62 (a phase displacement determination unit 62b to be described later) selects a candidate closest to the stored predicted interference signal maximum detection light amount I as the interference signal maximum detection light amount I.

In the example shown in FIG. 10A, in the calculation of a maximum light amount in a case in which cos 2α is positive and there is no phase deviation between the two beam spots requiring the highest sensitivity (Δh=0), a degree of contribution of (I_{α}−I_{-α}) from which the interference noise due to the back surface reflection is canceled is increased, and the influence of the noise in the calculation of the interference signal maximum detection light amount I can be prevented.

The polarization direction θᵣ to be obtained can be obtained by (Formula 12).

$$[ Formula 12 ]$$

$${θ}_{r} = 0.5 a tan 2 ( \frac{I - ( {I}_{α} + {I}_{- α} )}{I cos 2 α} , \frac{- ( {I}_{α} - {I}_{- α} )}{I sin 2 α} ) \qquad ( 12 )$$

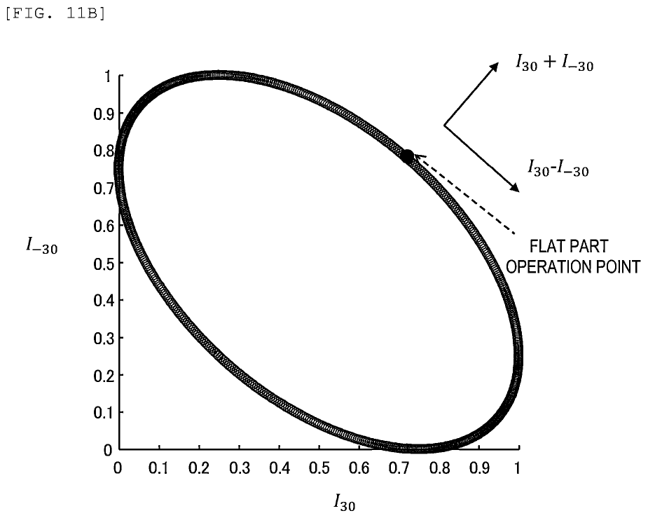

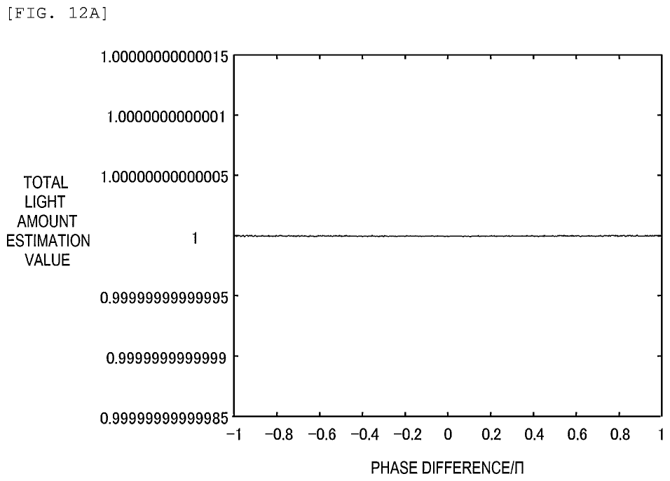

In the above description, the main noise which is the stray light explained as the back surface reflection from the objective lens 94 and/or the detection lens 4v, and when the noise can be completely excluded by the optical system shown in FIG. 8, the main noise that obstructs the high-sensitivity measurement may be, for example, thermal noise from the sensor. In such a case, for example, α is set to 67.5 degrees. A detection light amount for the phase between the beam spots at this time is shown in FIG. 12B. In this case, a detection light amount when there is no phase difference between the two beam spots requiring the highest sensitivity decreases, and (I_{α}+I_{-α}) at the flat part operation point is less than the value of the interference signal maximum detection light amount I and decreases to about ⅓ of that in FIG. 9A. The interference noise due to the back surface reflection is also reduced to ⅓ because the interference noise has the same component as the polarization direction of the reflected light when there is no phase difference. In contrast, a change in the value of (I_{α}−I_{-α}) that manifests the phase change is reduced to about 70%, and as a result, the contrast to the phase change is greatly improved. In particular, in a case in which the contrast to be measured is reduced due to interference caused by the noise from the back surface reflection, setting a to about 67.5 degrees may be more robust against the noise than setting a to 22.5 degrees. Further, FIGS. 11A and 11B show detection light amounts when α is set to 30 degrees. In this way, a can be set in various values.

In a method of reducing the detection light amount of (I_{α}+I_{-α}) by increasing α, the contrast is improved by decreasing a background brightness corresponding to (I_{α}+I_{-α}), and thus improvement in sensitivity can be expected. Therefore, an effect can be expected in other cases in which a minute defect is overlooked due to the resolution of a differential interference contrast detection system. Therefore, the rotation stages of the polarization filters 99A and 99B can be adjusted by a control device to be described later to set the rotation angles to symmetrical angles with respect to the polarization direction of the reflected light from the flat sample surface according to a purpose of the inspection.

In the present embodiment, the polarization directions are controlled by the rotatable polarization filters 99A and 99B, but the present invention is not limited to this configuration. For example, each polarization filter may be implemented by a combination of a half-wavelength plate and a polarization beam splitter. Even when the quarter-wavelength plate 92 is a half-wavelength wavelength plate, the same effect can be obtained by preventing the occurrence of a phase difference between two polarized light orthogonal to each other in the Nomarski prism 93.

### <<Control Device 71>>

The control device 71 is a computer that collectively controls the surface inspection apparatus 100, and includes a central processing unit (CPU), a field-programmable gate array (FPGA), a timer, and the like in addition to a read only memory (ROM), a random access memory (RAM), and other memories. The control device 71 implements a height shape measurement unit by the CPU executing shape measurement software stored in a memory.

The control device 71 is connected to the user interface 72, the monitor 73, and the signal processing device 6 in a wired or wireless manner. The user interface 72 is a device through which a user inputs various operations, and various input devices such as a keyboard, a mouse, a touch panel, and the like can be adopted as appropriate. Inspection conditions and the like received from the user interface 72 according to an encoder of the rotation stage or the translation stage and an operation of an operator are received by the control device 71. The inspection conditions include, for example, a type, a magnitude, a shape, a material, an illumination condition, and a detection condition of the sample 1. The polarization directions of the polarization filters 99A and 99B are also received.

The control device 71 outputs a command signal to command operations of the stage ST, the dark-field illumination optical system 3, the differential interference contrast illumination system 8, the differential interference contrast detection system 9, and the like according to the inspection conditions, and outputs coordinate data of the illumination spot 40 synchronized with a defect detection signal to the signal processing device 6. The control device 71 also displays and outputs a defect inspection result obtained by the signal processing device 6 on the monitor 73.

### <<Signal Processing Device 6>>

The signal processing device 6 is a computer that processes the detection signals received from the dark-field detection sensors 5v, 5-1, 5-2, . . . and the line sensors 5B1 and 5B2, and includes a CPU, an FPGA, a timer, and the like in addition to a ROM, a RAM, and other memories similarly to the control device 71. The signal processing device 6 is assumed to be implemented by a single computer that forms a unit with a device main body (a stage, an illumination optical system, a detection optical system, a sensor, and the like) of the surface inspection apparatus 100 as an example, and may be implemented by a plurality of computers. In this case, a server may be used as one of the plurality of computers. The signal processing device 6 includes the dark-field data processing unit 61 which processes dark-field data, the differential interference contrast processing unit 62 which processes a differential interference contrast signal, and a processing result integration unit 63 that integrates processing results of the dark-field data processing unit 61 and the differential interference contrast processing unit 62.

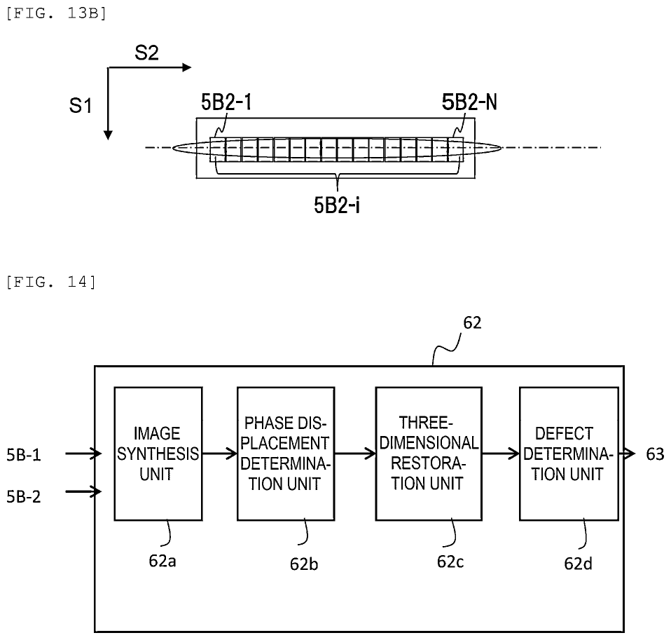

In the dark-field data processing unit 61, a defect is detected based on a change in scattered light intensity. Since the defect to be detected is minute with respect to the illumination beam spot, it is possible to use a method of extracting a high-frequency component in a time direction from the outputs of the dark-field detection sensors 5v, 5-1 to 5-2, . . . and regarding a large portion thereof as the defect. For example, a defect can be detected by using a method disclosed in PTL 2 in FIG. 13B. The processing result integration unit 63 integrates, based on coordinates at which the defect is detected, defect information detected by the dark-field data processing unit 61 and defect information detected by the differential interference contrast processing unit 62 to be described later, generates defect information including both feature values, and transfers a result thereof to the control device 71.

### <Differential Interference Contrast Processing Unit 62>

FIGS. 13A and 13B show the light reception units of the line sensors 5B1 and 5B2, respectively. In each of the line sensors 5B1 and 5B2, N pixels are arranged in the S2 direction shown in FIG. 2 or FIG. 3. The line sensors 5B1 and 5B2 are mounted on respective optical paths split by the half beam splitter 98-A. The pixels in the same arrangement, that is, pixels 5B1-i and pixels 5B2-i (1≤i≤N) are adjusted to capture an image of the same portion of the sample surface.

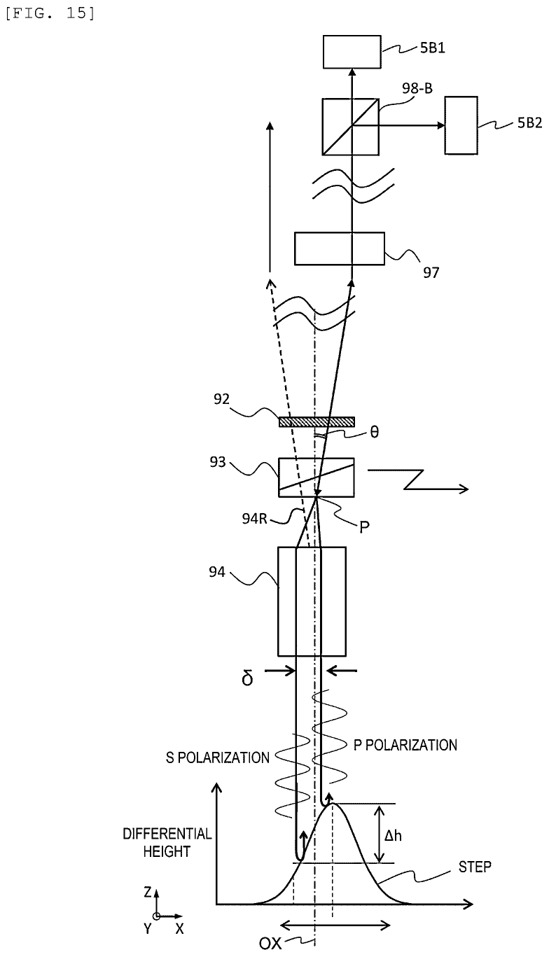

FIG. 14 is a diagram showing a configuration example of the differential interference contrast processing unit 62. An image synthesis unit 62a calculates an addition image and a subtraction image from signals output from the line sensors 5B1 and 5B2. A pixel value of the addition image indicates (I_{α}+I_{-α}), and a pixel value of the subtraction image indicates (I_{α}−I_{-α}). Since the pixels in the same arrangement of the line sensors 5B1 and 5B2 correspond to the same position of the sample surface, the pixels 5B1-1 to 5B1-N may be added to or subtracted from output values of the pixels 5B2-1 to 5B2-N, respectively. The phase displacement determination unit 62b calculates the polarization direction Or by performing the calculation of (Formula 11) and (Formula 12) for each pixel and calculates the phase deviation between the beam spots or the surface height.

A three-dimensional restoration unit 62c accumulates the phase deviation or the differential height in a shear direction to restore a three-dimensional structure of the sample surface. More specifically, the surface height is restored and a surface film thickness is reconstructed. A defect determination unit 62d detects the defect by comparing with a predetermined height threshold.

### Modification

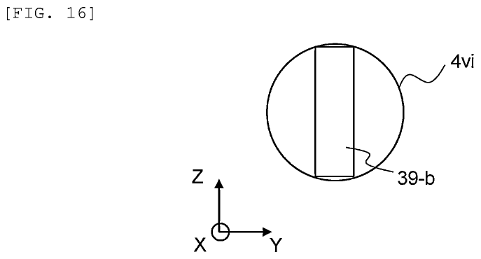

FIG. 15 is a modification of FIG. 8. In configuration example in FIG. 8, an example is shown in which the half beam splitter 98-A is applied for the optical path split, whereas FIG. 15 shows an example in which the optical path split is performed by applying a polarization beam splitter 98-B instead of the half beam splitter 98-A. By applying the polarization beam splitter 98-B, the polarization filters 99A and 99B are not necessary, and the use efficiency of the reflected light is improved. In contrast, in this configuration, the polarization directions detected by the line sensors 5B1 and 5B2 cannot be controlled. α is normally set to 45 degrees.

Instead of the line sensor having a plurality of pixels, a point sensor having a single pixel may be applied. In the present embodiment, it is described that the back reflection of the objective lens 94 or the detection lens 4v is separated to an outside of the light reception unit of the sensor. When the line sensor is applied, it is necessary to adjust the incident direction of the illumination light such that the back surface reflected light travels while being inclined in the short axis direction of the line sensor, whereas when the point sensor is applied, the back surface reflected light can be separated from the light reception unit no matter which direction the illumination light is incident on.

The invention is not limited to the embodiment described above and includes various modifications. The embodiment described above has been described in detail to describe the invention in an easy-to-understand manner, and the invention is not necessarily limited to including all the described configurations. A part of a configuration according to a certain embodiment can be replaced with a configuration according to another embodiment, and a configuration according to another embodiment can be added to a configuration according to a certain embodiment. A part of a configuration according to each embodiment may be added to, deleted from, or replaced with another configuration.

A part or all of configurations, functions, processing units, processing methods, and the like described above may be implemented by hardware such as an integrated circuit. The configurations, functions, and the like described above may be implemented by software by a processor interpreting and executing a program for implementing each function. Information such as a program, a table, and a file for implementing each function can be stored in a recording device such as a memory, a hard disk, and a solid state drive (SSD) or a recording medium such as a flash memory card and a digital versatile disk (DVD).

Control lines and information lines considered to be necessary for description are shown in each embodiment, and not all control lines and information lines in a product are necessarily shown. Actually, it may be considered that almost all the configurations are connected.

### REFERENCE SIGNS LIST

1: sample
100: surface inspection apparatus
ST: stage
ST1: sample table
ST2: scanning device
3: dark-field illumination optical system
31: laser light source
32: attenuator
32a: first polarization plate
32b: half-wavelength plate
32c: second polarization plate
33: emission light adjustment unit
33a, 33b: reflection mirror
34: beam expander
34a, 34b: lens
35: polarization control unit
35a: half-wavelength plate
35b: quarter-wavelength plate
36: light condensing optical unit
37, 38: reflection mirror
38a: adjustment mechanism
39-a: reflection mirror
39-b: bar-shaped mirror
4v, 4-1, 4-2, . . . : detection lens
4vi, 4-1i, 4-2i, . . . : image formation lens
40: illumination spot
5v, 5-1, 5-2, . . . : dark-field detection sensor
5B1, 5B2: line sensor
6: signal processing device
61: dark-field data processing unit
62: differential interference contrast processing unit
62a: image synthesis unit
62b: phase displacement determination unit
62c: three-dimensional restoration unit
62d: defect determination unit
63: processing result integration unit
71: control device
72: user interface
73: monitor
8: differential interference contrast illumination system
81: laser light source
82: attenuator
83: beam shaping unit
83a, 83b: Lens
84: lens
9: differential interference contrast detection system
91: half beam splitter
92: quarter-wavelength plate
93: Nomarski prism
94: differential interference contrast objective lens
94R: back surface reflected light
95: lens
96: dichroic mirror
97: image formation lens
98-A: half beam splitter
98-B: polarized beam splitter
99A, 99B: polarization filter

1. A surface inspection apparatus comprising:
a stage configured to support a sample;
a differential: interference contrast illumination system configured to emit illumination light;
a differential interference contrast detection system configured to emit the illumination light to positions deviated by a predetermined shear amount as two illumination spots having different phases and generate light in a first polarization direction and a second polarization direction different from each other from interference light obtained by interfering reflected light of the two illumination spots from a surface of the sample;
a first sensor configured to photoelectrically convert the light in the first polarization direction to generate a first interference signal;
a second sensor configured to photoelectrically convert the light in the second polarization direction to generate a second interference signal; and
a signal processing device configured to process the first interference signal and the second interference signal, wherein
the first polarization direction and the second polarization direction of the light generated by the differential interference contrast detection system are set such that an intensity of the first interference signal and an intensity of the second interference signal are the same at an operation point at which there is no phase difference between the two illumination spots.

2. The surface inspection apparatus according to claim 1, wherein
the first polarization direction and the second polarization direction are not orthogonal to each other.

3. The surface inspection apparatus according to claim 1, wherein
the first polarization direction and the second polarization direction are set to be symmetrical with respect to a polarization direction of the interference light obtained by interfering the reflected light of the two illumination spots in the differential interference contrast detection system when there is no phase difference between the two illumination spots obtained by illuminating the surface of the sample.

4. The surface inspection apparatus according to claim 1, wherein
a sum of the intensity of the first interference signal and the intensity of the second interference signal at the operation point at which there is no phase difference between the two illumination spots is larger than an intensity of an interference signal generated by photoelectrically converting the interference light obtained by interfering the reflected light of the two illumination spots in the differential interference contrast detection system by a virtual single sensor in which a polarization direction to be detected is equal to a polarization direction of the interference light.

5. The surface inspection apparatus according to claim 1, wherein
the differential interference contrast detection system includes a wavelength plate, a Nomarski prism, and an objective lens,
the illumination light passes through the wavelength plate, the Nomarski prism, and the objective lens in this order, and
the Nomarski prism separates the illumination light that has passed through the wavelength plate into light having two polarized components corresponding to the two illumination spots.

6. The surface inspection apparatus according to claim 1, wherein
the differential interference contrast detection system includes a half beam splitter configured to split the interference light, a first polarization filter configured to generate light in the first polarization direction from one of the interference light split by the half beam splitter, and a second polarization filter configured to generate light in the second polarization direction from the other of the interference light split by the half beam splitter, and
the first polarization filter and the second polarization filter are rotatable.

7. The surface inspection apparatus according to claim 1, wherein
when an intensity of an interference signal generated by photoelectrically converting the interference light obtained by interfering the reflected light of the two illumination spots in the differential interference contrast detection system by a virtual single sensor in which a polarization direction to be detected is equal to a polarization direction of the interference light is set as an interference signal maximum detection light amount, the signal processing device calculates a phase difference between the two illumination n spots by estimating the interference signal maximum detection light amount based on the intensity of the first interference signal and the intensity of the second interference signal.

8. The surface inspection apparatus according to claim 7, wherein
the signal processing device stores a predicted interference signal maximum detection light amount and selects, among a plurality of interference signal maximum detection light amount candidates estimated based on the intensity of the first interference signal and the intensity of the second interference signal, an interference signal maximum detection light amount candidate closest to the predicted interference signal maximum detection light amount.

9. The surface inspection apparatus according to claim 1, wherein
the differential interference contrast detection system includes a wavelength plate, a Nomarski prism, and an objective lens,
the illumination light passes through the wavelength plate, the Nomarski prism, and the objective lens in this order, and
the illumination light from the differential interference contrast illumination system is incident at a pupil position of the objective lens at a predetermined angle with respect to an optical axis of the objective lens, and the two illumination spots are incident perpendicularly to the surface of the sample.

10. The surface inspection apparatus according to claim 9, wherein
the illumination spot has an illumination intensity distribution long in one direction, and
the illumination light from the differential interference contrast illumination system is incident in a plane including a short diameter direction of the illumination spot and the optical axis of the objective lens at the predetermined angle with respect to the optical axis of the objective lens.

11. A surface inspection apparatus comprising:
a stage configured to support a sample;
a differential interference contrast illumination system configured to emit first illumination light; and
a differential interference contrast detection system that includes a wavelength plate, a Nomarski prism, and an objective lens, and that is configured to emit the first illumination light at positions deviated by a predetermined shear amount as two first illumination spots having different phases by causing the first illumination light to pass through the wavelength plate, the Nomarski prism, and the objective lens, configured to cause reflected light of the two first illumination spots from a surface of the sample to pass through the objective lens, the Nomarski prism, and the wavelength plate, and configured to obtain interference light obtained by interfering the reflected light of the two illumination spots, wherein
the first illumination light from the differential interference contrast illumination system is incident at a pupil position of the objective lens at a predetermined angle with respect to an optical axis of the objective lens, and the two first illumination spots are incident perpendicularly to the surface of the sample.

12. The surface inspection apparatus according to claim 11, wherein
the first illumination spot has an illumination intensity distribution long in one direction, and
the first illumination light from the differential interference contrast illumination system is incident in a plane including a short diameter direction of the first illumination spot and the optical axis of the objective lens at the predetermined angle with respect to the optical axis of the objective lens.

13. The surface inspection apparatus according to claim 11, further comprising:
a detection lens, wherein
the differential interference contrast detection system further includes a lens configured to condense images of the two first illumination spots formed by the objective lens, and
the detection lens projects light condensed by the lens onto the surface of the sample as the two first illumination spots, and detects reflected light of the two first illumination spots from the surface of the sample.

14. The surface inspection apparatus according to claim 13, further comprising:
a dark-field illumination optical system that includes a dark-field illumination light source configured to emit second illumination light having a wavelength different from a wavelength of the first illumination light from the differential interference contrast illumination system, and that is configured to cause the second illumination light to be incident on the sample obliquely to form a second illumination spot on the surface of the sample, wherein
the differential interference contrast detection system further includes a dichroic mirror disposed between the lens and the detection lens, and
the dichroic mirror separates the reflected light of the two first illumination spots from scattered light of the second illumination spot.

15. The surface inspection apparatus according to claim 14, further comprising:
a dark-field detection sensor configured to detect the scattered light of the second illumination spot emitted from the dichroic mirror;
an image formation lens configured to form an image of the scattered light of the second illumination spot on the dark-field detection sensor; and
an epi-illumination optical system including a mirror configured to reflect the second illumination light from the dark-field illumination light source and guide the reflected second illumination light to the dichroic mirror, wherein
the detection lens projects the second illumination light guided to the dichroic mirror onto the surface of the sample as a third illumination spot, condenses reflected light of the third illumination spot, and guides the condensed reflected light to the dichroic mirror, and
the mirror of the epi-illumination optical system is disposed between the dichroic mirror and the image formation lens, and of the reflected light of the third illumination spot emitted from the dichroic mirror, light that is not blocked by the mirror is detected by the dark-field detection sensor.
